(19) United States
(12) Patent Application Publication
(10) Pub. No.: US 2026/0162401 A1
(43) Pub. Date: Jun. 11, 2026

(54) PHYSICAL VARIANCE DETECTION AUTOMATA

(71) Applicant: DISNEY ENTERPRISES, INC., Burbank, CA (US)

(72) Inventors: James H. TATUM, III, Anaheim, CA (US); Jason Erinn DE ARTE, Yorba Linda, CA (US); Jason Alexander COX, Valencia, CA (US)

(21) Appl. No.: 18/977,698

(22) Filed: Dec. 11, 2024

(51) Int. Cl. G06V 10/75; G06V 10/74; G06V 10/774; G06V 10/82; G06V 20/70

(52) U.S. Cl. CPC G06V 10/751; G06V 10/761; G06V 10/774; G06V 10/82; G06V 20/70

(57) ABSTRACT

The present invention sets forth a technique for performing automated physical variance detection. The technique includes recording, via a capture device, a sample representation of a scene including one or more objects and selecting a baseline representation of the scene from a baseline database. The technique also includes generating, via a machine learning model, a variance probability value associated with each of one or more pixels included in the sample representation. The technique further includes generating a variance label associated with the sample representation and transmitting at least the sample representation and the variance label to the capture device.

### BACKGROUND

### Field of the Various Embodiments

Embodiments of the present disclosure relate generally to computer vision and, more specifically, to techniques for performing automatic physical variance detection in a scene including one or more objects.

### Description of the Related Art

Physical variance detection refers to the comparison of two or more representations of a physical scene and the detection of one or more differences between the representations of the scene. For example, a physical variance detection technique may determine that one or more objects included in a baseline representation of a scene may be missing from a subsequently acquired sample representation of the same scene. A physical variance detection technique may also determine that one or more objects included in a sample representation of a scene are not present in an earlier baseline representation of the scene. In addition to detecting missing or newly added objects, variance detection techniques may further determine that one or more objects present in both a baseline representation and a sample representation of a scene have experienced a change in position, orientation, and/or appearance between the baseline and sample representations. Physical variance detection techniques are useful for, e.g., comparing a current configuration of objects included in an amusement park attraction to a known, proper baseline configuration of the attraction. Physical variance detection techniques may also be used to analyze before and after depictions of an area to detect damage from a natural disaster or civil unrest. Physical variance detection techniques may also inform inventory control processes by identifying missing or newly added objects in a storage facility.

Existing techniques for physical variance detection may require a visual examination of a scene by a human evaluator. The visual examination may rely solely on the evaluator's recollection of the proper baseline configuration for the scene, or may be guided by one or more manual checklists and/or reference depictions of the scene. Visual examination of a scene may be slow and prone to errors, leading to cursory and/or infrequent evaluations of the scene. These evaluations may fail to detect changes in a scene or may not detect changes within an acceptable time frame.

Other existing techniques may include an automated pixel-wise comparison of a baseline representation of a scene to a sample representation of a scene. The baseline and sample representations of the scene may include, e.g., raster images such as digital photographs. These automated techniques may rely on precise alignment between the baseline and sample representations, such that a collection of pixels representing a particular object in a scene are located at the same positions in both the baseline and sample representations. The techniques may be susceptible to errors based on misalignments between the baseline and sample representations, such as instances where the baseline and sample representations are captured from different camera locations and/or camera viewing angles. These techniques may also falsely identify differences between the baseline and sample representations based on differences in lighting or other environmental conditions between the baseline and sample representations.

As the foregoing illustrates, what is needed in the art are more effective techniques for performing automated physical variance detection.

### SUMMARY

One embodiment of the present invention sets forth a technique for performing automated variance detection. The technique includes recording, via a capture device, a sample representation of a scene including one or more objects and selecting a baseline representation of the scene from a baseline database. The technique also includes generating, via a machine learning model, a variance probability value associated with each of one or more pixels included in the sample representation, generating a variance label associated with the sample representation, and transmitting at least the sample representation and the variance label to the capture device.

One technical advantage of the disclosed techniques relative to the prior art is that the disclosed techniques enable automated variance detection in a scene, without requiring checklists or manual human review of reference representations of the scene. The disclosed techniques also enable variance detection based on baseline and sample representations of a scene captured under varying lighting conditions or captured from different sensor viewpoints. These technical advantages provide one or more improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of various embodiments.

FIG. 2 is a more detailed illustration of the training engine of FIG. 1, according to some embodiments.

FIG. 3 is a flow diagram of method steps for training a machine learning model to perform automated variance detection, according to some embodiments.

FIG. 4 is a more detailed illustration of the inference engine of FIG. 1, according to some embodiments.

FIG. 5 is a flow diagram of method steps for performing automated variance detection, according to some embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

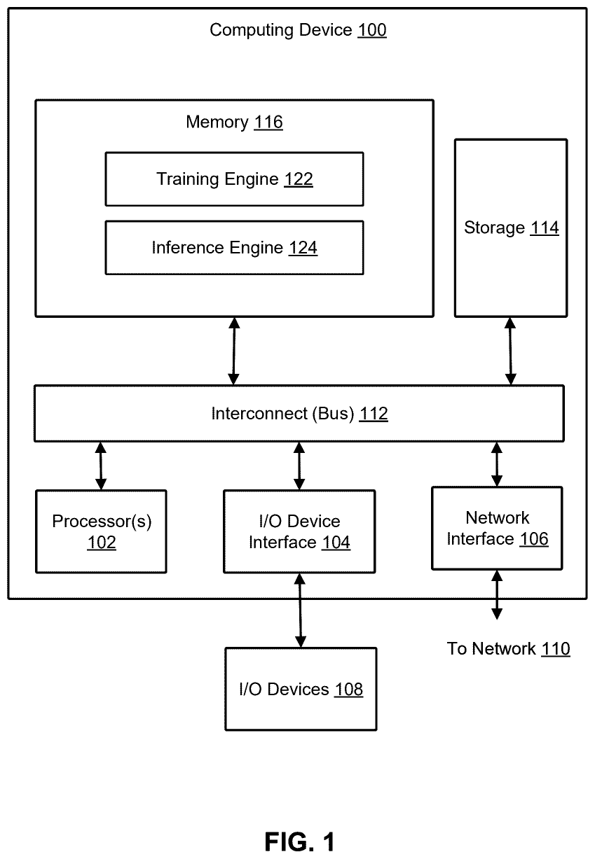

FIG. 1 illustrates a computing device 100 configured to implement one or more aspects of various embodiments. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a training engine 122 and an inference engine 124 that resides in a memory 116.

It is noted that the computing device described herein is illustrative and that any other technically feasible configurations fall within the scope of the present disclosure. For example, multiple instances of training engine 122 and/or inference engine 124 could execute on a set of nodes in a distributed and/or cloud computing system to implement the functionality of computing device 100. In another example, training engine 122 and/or inference engine 124 could execute on various sets of hardware, types of devices, or environments to adapt training engine 122 and/or inference engine 124 to different use cases or applications. In a third example, training engine 122 and/or inference engine 124 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Training engine 122 and/or inference engine 124 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including training engine 122 and/or inference engine 124.

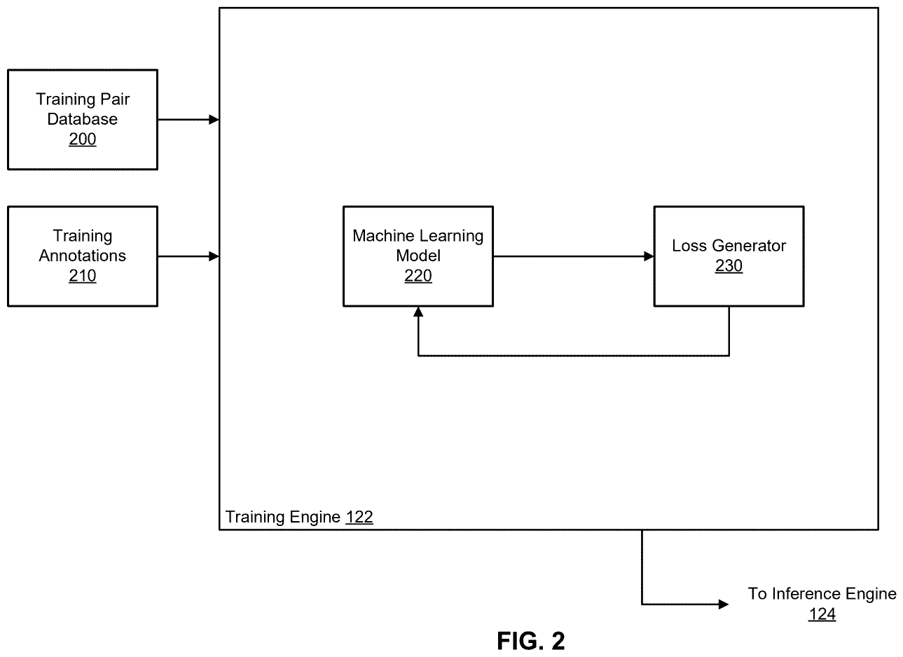

FIG. 2 is a more detailed illustration of training engine 122 of FIG. 1, according to some embodiments. Training engine 122 modifies one or more machine learning models to recognize variance between the presence, location, or appearance of various objects depicted in an annotated training pair of scene representations included in training pair database 200. Training engine 122 may also receive training annotations 210 associated with the training pairs of representations. Training engine 122 includes, without limitation, machine learning model 220 and loss generator 230.

Training pair database 200 includes multiple training pairs, where each training pair includes a baseline representation of a scene and a sample representation of the scene. A scene may include any place or location including one or more objects, such as decorative items, furnishings, or structural elements such as doors or walls. For example, a scene may depict a film set, a stage set, a hotel room, an amusement park attraction, a manufacturing or other industrial facility, or an arrangement of items in a warehouse. A scene may also depict an exterior view of a building, a roadway, or one or more natural terrain features, such as trees, mountains, valleys, or moving or still bodies of water.

Training pair database 200 may include training pairs captured via one or more of multiple modalities, where each training pair includes a baseline representation and a sample representation captured via the same modality. For example, representations included in a training pair may include a point cloud, or color or black-and-white raster images, such as digital photographs. Representations may also include depictions of a scene captured via an infrared imaging device, a Light Detection and Ranging (LiDAR) imaging device, an ultrasonic imaging device, or any other suitable sensor.

In various embodiments, one or more sample representations included in training pair database 200 may include artificially generated features. For example, a generative artificial intelligence machine learning model may generate, based on a baseline representation, one or more features that each exhibit a variance compared to the baseline representation. Variances associated with artificially generated features may include features that are present in the baseline representation but missing in the generated sample representation. Variances associated with an artificially generated feature may also include features that are present in the sample representation but not present in the baseline representation, or features that exhibit a change in position, orientation, and/or appearance between the baseline representation and the sample representation. In various embodiments, one or more baseline and/or sample representations included in training pair database 200 may include features generated by a digital twin system, where the digital twin system includes a set of one or more adaptive models that emulate the behavior of a physical system in a virtual system. For example, a digital twin system may emulate a scene, and training pair database 200 may include a baseline representation of the scene based on the digital twin system emulation. Training pair database may also include one or more sample representations of the scene based on variances entered into the digital twin system.

Each representation included in a training pair may include an arrangement of pixels, the arrangement having a defined resolution expressed as a width and a height expressed as a number of pixels. In various embodiments, each pixel may include a luminance value, one or more color values, such as red, green, and blue, or a relative or absolute depth value. In various embodiments, both representations included in a training pair may have the same defined resolution.

A training pair may include a baseline representation and a sample representation, where the scene depicted in the sample representation exhibits little or no variance compared to the baseline representation included in the training pair. Alternatively, a training pair may include a baseline representation and a sample representation, where the scene depicted in the sample representation exhibits at least a threshold amount of variance compared to the baseline representation included in the training pair. For example, a scene depicted by a sample representation may include one or more objects that are not present in the scene depicted by the baseline representation. A scene depicted by a sample representation may not include one or more objects that are present in the scene depicted by the baseline representation. A scene depicted by a sample representation may include one or more objects whose appearance, location, or orientation differ from the depiction of the same one or more objects in the baseline representation.

Training annotations 210 include one or more user-supplied annotations associated with one or more training pairs included in training pair database 200. While training annotations 210 is shown as a separate component, in various embodiments the user-supplied annotations associated with a particular training pair may be included in training pair database 200. In various embodiments where training pair database includes one or more baseline and/or sample representations produced by a generative artificial intelligence machine learning model and/or a digital twin system, the generative artificial intelligence machine learning model and/or the digital twin system may also generate one or more annotations associated with the baseline and/or sample representations.

Training annotations 210 associated with a particular training pair may include a label indicating whether there is greater than or less than a threshold amount of variance between the baseline and sample representations included in the training pair. For example, an annotation included in training annotations 210 may designate a training pair as “nominal” if there is less than a threshold amount of variance between the baseline and sample representations. An annotation included in training annotations 210 may designate a training pair as having “variance” if there is more than a threshold amount of variance between the baseline and sample representations.

Training annotations 210 associated with a particular training pair may also include textual labels associated with one or more objects included in either or both of the baseline representation and the sample representation. A textual label may be associated with a contiguous region of pixels included in the baseline representation or the sample representation. Alternatively, a textual label may be associated with two or more non-contiguous regions of pixels included in the baseline representation or the sample representation. For example, a training annotation included in training annotations 210 and associated with a particular training pair may identify a region of pixels included in a baseline image as depicting a desk or a painting. A different training annotation included in training annotations 210 may identify multiple non-contiguous regions included in a baseline image as depicting windows.

A training annotation included in training annotations 210 may include one or more measures of variance associated with a sample image. For example, a training annotation may include a vector matrix of values, where each value is associated with a different pixel included in a sample representation and expresses a probability that the associated pixel in the sample representation exhibits a variance compared to a corresponding pixel included in the baseline representation. In various embodiments, each value may include a real value taken from the range of 0 to 1, where a value of 0 indicates a lowest probability of variance and a value of 1 indicates a highest probability of variance.

A training annotation included in training annotations 210 may include one or more bounding box logits, where each bounding box logit represents a rectangular region of pixels included in a sample representation that collectively exhibit a variance compared to corresponding pixels included in the baseline representation. A bounding box logit may include two pairs of pixel coordinates (X1, Y1) and (X2, Y2), where (X1, Y1) describes the pixel coordinates within the sample image that define one corner of a bounding box and (X2, Y2) describes the pixel coordinates within the sample image that define an opposite corner of the bounding box. A training annotation may also include a textual label associated with a bounding box logit describing the variance, such as “missing painting” or “newly included object.”

Machine learning model 220 includes one or more machine learning models, such as convolutional neural networks. Training engine 122 modifies one or more internal weights included in machine learning model 220 based on a loss function value generated by loss generator 230 described below. Machine learning model 220 accepts a baseline representation depicting a scene and a sample representation depicting the same scene, and generates one or more measures of variance between the baseline and sample representations.

Training engine 122 transmits a training pair included in training pair database to machine learning model 220. Training engine 122 may also transmit one or more training annotations associated with the training pair to machine learning model 220. Training engine 122 aligns and concatenates the baseline and sample representations included in the training pair. For example, training engine 122 may arrange the baseline and sample representations adjacent to one another, such that a right-hand edge of the baseline representation abuts a left-hand edge of the sample representation. In various embodiments, training engine 122 generates a sliding window that spans both pixels included in the baseline representation and pixels included in the sample representation. Training engine 122 transmits the pixels spanned by the sliding window to an input layer included in machine learning model 220. Training engine 122 may then reposition the sliding window such that the sliding window spans a different collection of pixels and transmit the different set of pixels to machine learning model 220. Training engine 122 may continue to reposition the sliding window until all pixels included in both the baseline and sample representations have been transmitted to machine learning model 220 at least once.

Machine learning model 220 determines a pixel-wise probability of variance for one or more pixels included in the sample representation from a training pair. In various embodiments, machine learning model 220 may generate a vector matrix of values as described above, where each value is associated with a different pixel included in the sample representation and expresses a probability that the associated pixel in the sample representation exhibits a variance compared to a corresponding pixel included in the baseline representation. In various other embodiments, machine learning model 220 may generate one or more bounding box logits, where each bounding box logit represents a rectangular region of pixels included in a sample representation that collectively exhibit a variance compared to corresponding pixels included in the baseline representation. As described above, a bounding box logit may include two pairs of pixel coordinates (X1, Y1) and (X2, Y2), where (X1, Y1) describes the pixel coordinates within the sample image that define one corner of a bounding box and (X2, Y2) describes the pixel coordinates within the sample image that define an opposite corner of the bounding box. In various embodiments, machine learning model 220 may generate values between 0 and 1 for each of X1, Y1, X2, and Y2. These values, when multiplied by either the height or the width of the sample image in pixels, specify particular pixel locations within the sample image. For example, given a sample image having a width of 600 pixels and a height of 300 pixels, an X1 value of 0.25, when multiplied by the pixel width of 600, designates a pixel included in the sample image having an X coordinate of 150. Likewise, a Y1 value of 0.75, when multiplied by the pixel height of 300, designates a pixel included in the sample image having a Y coordinate of 225. The (X1, Y1) values of 0.25 and 0.75 therefore describe a corner of a bounding box having coordinates of (150, 225) in the sample representation.

In various embodiments where training pair database 200 includes training pairs having different modalities (raster images, LiDAR images, ultrasonic images, etc.), training engine 122 may train machine learning model 220 on multiple training pairs having the same modality. As described above, machine learning model 220 may include multiple machine learning models, where training engine 122 trains each of the multiple machine learning models on training pairs having a different modality. For example, training engine 122 may train one machine learning model included in machine learning model 220 to identify variance in baseline and sample representations in raster format, while training engine 122 may train a different machine learning model included in machine learning model 220 to identify variance in baseline and sample representations in LiDAR format.

Machine learning model 220 generates an output based on the training pair input and transmits the output to loss generator 230. As described above, the output from machine learning model 220 may include one or more bounding box logits or a vector matrix of pixel-wise variance probabilities.

Loss generator 230 calculates a loss value based on the output from machine learning model 220 and one or more training annotations included in training annotations 210 and associated with the training pair provided as input to machine learning model 220. In various embodiments, the loss value may represent a pixel-wise summation of differences between variance probability values calculated by machine learning model 220 and variance probability values included in the one or more training annotations. Loss generator 230 may also calculate a loss based on a comparison between a “nominal” or “variance” label generated by machine learning model 220 and a “nominal” or “variance” labeled included in training annotations 210. Loss generator 230 may further calculate a loss value based on differences between one or more bounding box logits calculated by machine learning model 220 and one or more bounding box logits included in the one or more training annotations. Based on the loss value calculated by loss generator 230, training engine 122 may iteratively modify one or more internal weights included in machine learning model 220. Training engine 122 may continue to iteratively modify machine learning model 220 based on loss values associated with multiple training pairs, until the calculated loss values are below a predetermined threshold.

As described above, training engine 122 may iteratively modify multiple different machine learning models included in machine learning model 220, where training engine 122 modifies each machine learning model to detect variance in training pairs having a different modality. Training engine 122 transmits the one or more trained machine learning models to inference engine 124 described below.

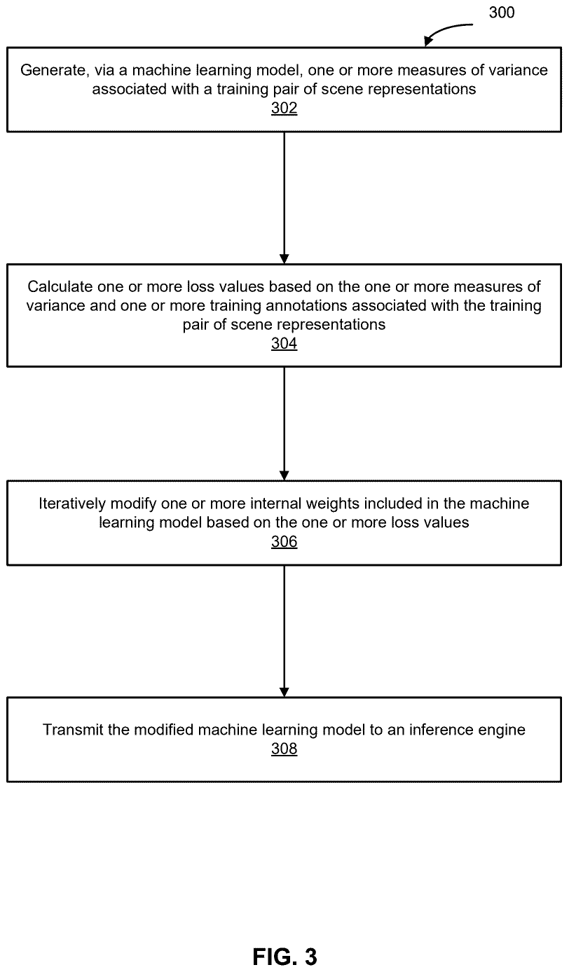

FIG. 3 is a flow diagram of method steps for training a machine learning model to perform automated variance detection, according to some embodiments. Although the method steps are described in conjunction with the systems of FIGS. 1 and 2, persons skilled in the art will understand that any system configured to perform the method steps in any order falls within the scope of the present disclosure.

As shown, in operation 302 of method 300, training engine 122 generates, via machine learning model 220, one or more measures of variance associated with a training pair of scene representations, where the training pair includes a baseline representation of a scene and a sample representation of the scene. In various embodiments, the one or more measures of variance may include pixel-wise variance probabilities associated with one or more pixels included in the sample representation. In other embodiments, the one or more measures of variance may include one or more bounding box logits, where the one or more bounding box logits indicate one or more regions of pixels included in the sample representation that exhibit variance compared to one or more corresponding regions of pixels included in the baseline representation. The one or more measures of variance may include a label generated by machine learning model 220 and associated with the sample representation included in the training pair. For example, machine learning model 220 may generate a label of “nominal” associated with a sample representation that exhibits less than a threshold amount of variance compared to a corresponding baseline representation. Likewise, machine learning model 220 may generate a label of “variance” associated with a sample representation that exhibits greater than a threshold amount of variance compared to the corresponding baseline representation.

In step 304, loss generator 230 of training engine 122 calculates one or more loss values based on the one or more measures of variance and one or more training annotations associated with the training pair of scene representations. Training engine 122 may calculate the one or more loss values based on a summation of pixel-wise variance probability differences between pixel variance probabilities generated by machine learning model 220 and pixel variance probabilities associated with a sample representation and included in training annotations 210.

Loss generator 230 may also calculate the one or more loss values based on difference between one or more bounding box logits generated by machine learning model 220 and one or more bounding box logits included in training annotations 210. Loss generator 230 may further calculate the one or more loss values based on a label, such as “nominal” or “variance,” generated by machine learning model 220 and a label included in training annotations 210.

In step 306, training engine 122 iteratively modifies one or more internal weights included in machine learning model 220 based on the loss values calculated by loss generator 230. Training engine 122 may continue to iteratively modify machine learning model 220 based on additional training pairs included in training pair database until one or more loss values calculated by loss generator 230 are below one or more predetermined thresholds.

In step 308, training engine 122 transmits the modified machine learning model to inference engine 124 described below. In various embodiments where training pair database 200 includes training pairs captured via different modalities, e.g., raster images, LiDAR images, ultrasonic images, training engine 122 may train a single machine learning model included in machine learning model 220 one multiple training pairs, where the multiple training pairs include scene representations captured via the same modality. Training engine 122 may repeatedly execute some or all of steps 302, 304, 306, or 308 to modify one or more additional machine learning models included in machine learning model 220, such that each of the one or more machine learning models included in machine learning model 220 is modified to identify variance in a training pair having a different modality.

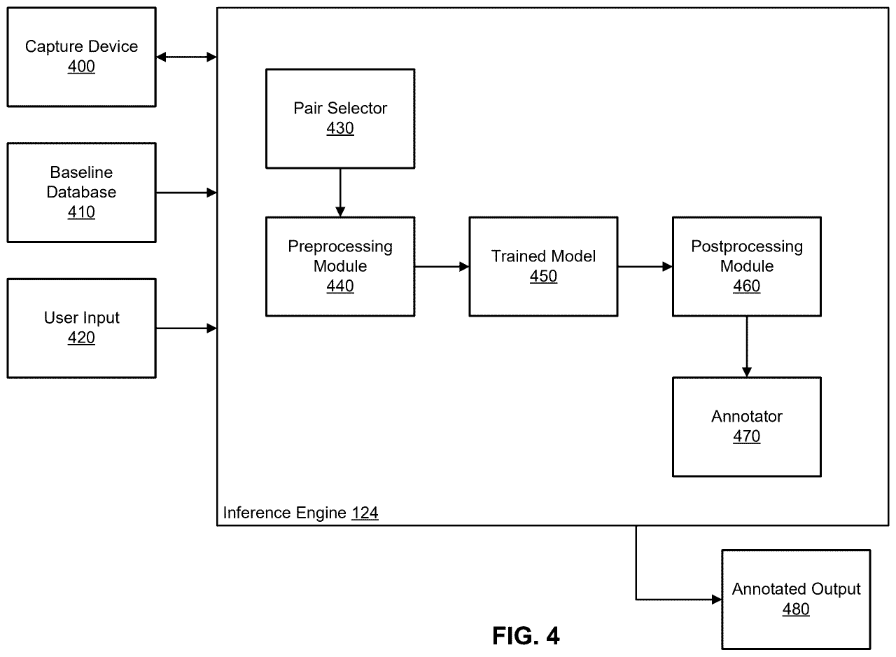

FIG. 4 is a more detailed illustration of inference engine 124 of FIG. 1, according to some embodiments. Inference engine 124 receives a sample representation of a scene via capture device 400 and a baseline representation of the scene selected from a baseline database 410. Inference engine 124 may select the baseline representation automatically or based on user input 420. Inference engine 124 detects one or more variances between the baseline and sample representations, such as objects that are present in one representation and missing in the other representation, or objects whose position, orientation, or appearance differ between the baseline and sample representations. Inference engine 124 generates annotated output 480 that includes the sample representation of the scene and one or more visual or textual indications of variance. Inference engine 124 includes, without limitation, pair selector 430, preprocessing module 440, trained model 450, postprocessing module 460, and annotator 470.

Capture device 400 includes one or more sensors operable to record a sample representation of a scene. The one or more sensors may include a digital camera sensor, a LiDAR sensor, an ultrasonic sensor, an infrared sensor, an audio sensor, or a point cloud generator. In various embodiments, capture device 400 may also include a graphical display and a user interface. Examples of capture device 400 include, without limitation, a camera included in a portable telephone, a laptop or tablet computer, a digital camera (still or video), an audio recording device, or a dedicated LiDAR, ultrasonic, or infrared sensor. In various embodiments, capture device 400 may communicate with inference engine 124 or other components via network 110.

In various embodiments, a user may record a sample representation of a scene via capture device 400. A scene may include any place or location including one or more objects, such as decorative items, furnishings, or structural elements such as doors or walls. For example, a scene may depict a film set, a stage set, a hotel room, an amusement park attraction, a manufacturing or other industrial facility, or an arrangement of items in a warehouse. A scene may also depict an exterior view of a building, a roadway, or one or more natural terrain features, such as trees, mountains, valleys, or moving or still bodies of water.

Baseline database 410 includes one or more baseline representations of one or more scenes. The one or more baseline representations may include baseline representations captured via different modalities, such as digital raster images, point clouds, LiDAR images, ultrasonic images, or infrared images. Each of the one or more baseline representations includes an associated resolution expressed as a height and width in pixels. Each of the one or more baseline representations may also include one or more annotations associated with one or more regions included in the baseline representation. A region included in the baseline representation may include a selection of contiguous or non-contiguous pixels included in the baseline representation. For example, an annotation may specify a contiguous region of pixels and include a textual label identifying the contiguous region of pixels as a painting.

User input 420 may include one or more items of user-supplied data. User input 420 may include a manual selection of a baseline representation included in baseline database 410. User input 420 may also include a textual label identifying a sample representation recorded via capture device 400, such as “Room 214,” “Haunted House,” or “North Wall—Exterior.” User input 420 may also include a user entry or selection identifying a modality associated with a recorded sample representation, such as “Digital Photo,” “LiDAR image,” or “Point Cloud.” In various embodiments, a user may supply user input 420 via capture device 400. For example, a portable telephone may be operable to both record a sample representation and receive user input 420.

Inference engine 124 receives a sample representation of a scene from capture device 400 and transmits the sample representation to pair selector 430. Pair selector 430 selects, from baseline database 410, a baseline representation that corresponds to the received sample representation. A corresponding baseline representation may depict the same scene as the received sample representation via the same modality as the received sample representation, e.g., a digital raster image, a LiDAR image, or a point cloud.

In various embodiments, pair selector 430 may compare the captured sample representation to one or more baseline representations included in baseline database 410 via any suitable image comparison technique. Pair selector 430 may automatically select a single suitable baseline representation based on a similarity to the captured sample representation. Alternatively, pair selector 430 may select multiple baseline representation based on the comparisons and present the multiple baseline representations to a user via capture device 400 or one of I/O devices 108.

In various other embodiments, pair selector 430 may receive a user selection of a baseline representation. The user may select any baseline representation included in baseline database 410. Alternatively, the user may select from multiple baseline representations presented to the user by pair selector 430. Pair selector 430 transmits the captured sample representation and the selected baseline representation to preprocessing module 440.

Preprocessing module 440 analyzes the captured sample representation and the selected baseline representation and modifies the captured sample representation based on one or more characteristics of the selected baseline representation. Preprocessing module 440 may adjust a resolution of the captured sample representation to match a resolution of the selected baseline representation via any suitable upscaling or downscaling techniques. Preprocessing module 440 may also rotate or scale the captured sample representation to align the captured sample representation to the selected baseline representation. Preprocessing module 440 may further perform image-wide adjustments to the captured sample representation, including adjustments to image brightness, contrast, or sharpness based on corresponding image-wide brightness, contrast, or sharpness measurements associated with the selected baseline representation. Preprocessing module 440 transmits the selected baseline representation and the modified sample representation to trained model 450.

Trained model 450 includes one or more machine learning models that have been previously trained to detect variances between a baseline representation of a scene and a sample representation of the scene. In various embodiments, trained model 450 may include the one or more machine learning models included in machine learning model 220 discussed above in the description of FIG. 2. Each of the one or more previously trained machine learning models may include a convolutional neural network trained to detect variances in input baseline and sample representations having a particular modality, such as raster images, LiDAR images, or point clouds.

Inference engine 124 aligns and concatenates the baseline and sample representations received from preprocessing module 440. For example, inference engine 124 may arrange the baseline and sample representations adjacent to one another, such that a right-hand edge of the baseline representation abuts a left-hand edge of the sample representation. In various embodiments, inference engine 124 generates a sliding window that spans both pixels included in the baseline representation and pixels included in the sample representation. Inference engine 124 transmits the pixels spanned by the sliding window to an input layer included in trained model 450. Inference engine 124 may then reposition the sliding window such that the sliding window spans a different collection of pixels and transmit the different set of pixels to trained model 450. Inference engine 124 may continue to reposition the sliding window until all pixels included in both the baseline and sample representations have been transmitted to trained model 450 at least once.

Trained model 450 determines a pixel-wise probability of variance for one or more pixels included in the captured sample representation. In various embodiments, trained model 450 may generate a vector matrix of values, where each value is associated with a different pixel included in the sample representation and expresses a probability that the associated pixel in the sample representation exhibits a variance compared to a corresponding pixel included in the baseline representation. In various other embodiments, trained model 450 may generate one or more bounding box logits, where each bounding box logit represents a rectangular region of pixels included in the sample representation that collectively exhibit a variance compared to corresponding pixels included in the baseline representation. A bounding box logit may include two pairs of pixel coordinates (X1, Y1) and (X2, Y2), where (X1, Y1) describes the pixel coordinates within the sample representation that define one corner of a bounding box and (X2, Y2) describes the pixel coordinates within the sample representation that define an opposite corner of the bounding box. In various embodiments, trained model 450 may generate values between 0 and 1 for each of X1, Y1, X2, and Y2. These values, when multiplied by either the height or the width of the sample image in pixels, specify particular pixel locations within the sample image. For example, given a sample representation having a width of 600 pixels and a height of 300 pixels, an X1 value of 0.25, when multiplied by the pixel width of 600, designates a pixel included in the sample representation having an X coordinate of 150. Likewise, a Y1 value of 0.75, when multiplied by the pixel height of 300, designates a pixel included in the sample representation having a Y coordinate of 225. The (X1, Y1) values of 0.25 and 0.75 therefore describe a corner of a bounding box having coordinates of (150, 225) in the sample representation.

Based on the generated vector matrix of probability values and generated bounding box logits (if any), trained model 450 may generate a label associated with the captured sample image. A label of “nominal” may indicate that any variance detected by trained model 450 falls below a predetermined threshold, while a label of “variance” may indicate that trained model 450 detected an amount of variance that exceeds a predetermined threshold. Trained model 450 transmits the captured sample representation, the baseline representation, one or more annotations associated with the baseline representation, the generated vector matrix of values, the generated bounding box logits, and/or the generated label to postprocessing module 460.

Postprocessing module 460 analyzes the variance probability results generated by trained model 450 and prepares one or more output images for later annotation and presentation to a user. In various embodiments, the one or more output images are based on the captured sample representation received from trained model 450.

In various embodiments, postprocessing module 460 may generate a probability heat map based on the captured sample representation and the variance probability results generated by trained model 450. For each pixel included in the captured sample representation, postprocessing module 460 may adjust a brightness or color value associated with the pixel based on a variance probability calculated by trained model 450 and associated with the pixel. For example, postprocessing module 460 may divide a range of received probability results into two or more numerical ranges, and assign a different color or brightness value to each of the numerical ranges. For each pixel included in the captured sample representation, postprocessing module 460 modifies the color or brightness value associated with the pixel based on the variance probability associated with the pixel.

Postprocessing module 460 may also insert one or more bounding boxes into the captured sample representation based on the bounding box logits generated by trained model 450. Postprocessing module 460 may represent a bounding box as a rectangular overlay inserted into the captured sample image, where the opposite corners of the rectangular overlay are defined by the bounding box logits as described above. Postprocessing module may associate a color with the rectangular overlay such that the color of the overlay contrasts with colors associated with pixels included in the captured sample representation that are adjacent to the inserted rectangular overlay. In various embodiments, postprocessing module 460 may generate a probability heat map as described above and insert one or more bounding boxes into the generated heat map. Postprocessing module 460 transmits the generated vector matrix of variance probability values and the captured sample representation as modified with one or more of a heat map or bounding boxes to annotator 470.

Annotator 470 generates one or more textual labels associated with a modified sample representation. Annotator 470 receives the generated vector matrix of variance probability values, the modified sample representation, and the variance label from postprocessing module 460. Annotator 470 also receives the selected baseline representation from inference engine 124.

Annotator 470 associates the variance label generated by trained model 450, e.g. “nominal” or “variance”, with the modified sample representation. In an instance where trained model 450 has generated a label of “variance,” annotator 470 also identifies one or more regions included in the modified sample representation and associated with detected variances. In various embodiments, annotator 470 may identify the one or more regions based on bounding boxes generated by postprocessing module 460, a heat map generated by postprocessing module 460, or the vector matrix of variance probability values generated by trained model 450. For each identified region in the modified sample representation, annotator 470 compares one or more pixels included in the identified region to one or more corresponding pixels included in the baseline representation. Based on the comparison, annotator 470 may determine that an object present in the baseline representation is absent from the modified sample representation, or that an object present in the modified sample representation is not present in the baseline representation. Annotator 470 may also determine, based on the comparison, that an object included in both the baseline and modified sample representations has exhibited a change in orientation and/or appearance in the modified sample representation compared the baseline representation. Based on the comparisons, annotator 470 may generate textual labels associated with the one or more identified regions, such as “missing object,” “newly added object,” or “changed object.”

Annotator 470 may further refine the generated textual labels based on one or more user annotations associated with the baseline representation. For example, if annotator 470 identifies a missing or changed object in a region included in the modified sample representation, and determines that a corresponding region of the baseline representation includes an associated annotation of “painting,” annotator 470 may refine the generated textual label of “missing object” or “changed object” by replacing the textual label with a different textual label of “missing painting” or “changed painting.” In various embodiments, annotator 470 may generate a label associated with a newly added object. In these embodiments, annotator 470 may include a trained machine learning model, such as a multimodal large language model, that is operable to generate a descriptive textual label associated with an input image. Annotator 470 may transmit a collection of pixels associated with the region that includes the newly added object to the trained machine learning model and receive a descriptive textual label from the trained machine learning model. Annotator 470 may replace a previously generated textual label of “newly added object” with a different textual label of “newly added ‘X’,” where ‘X’ is the descriptive textual label generated by the trained machine learning model. In various embodiments, the trained machine learning model may generate one or more sentences describing a scene, as well as variances between a baseline representation of the scene and a sample representation of the scene. For example, the trained machine learning model may generate a description stating that the modified sample representation “depicts a hotel room, where the hotel room includes a painting of flowers that is not present in the baseline representation of the hotel room. Further, a vase included in the baseline representation of the hotel room is missing from the input image.”

Inference engine 124 generates annotated output 480 based on the baseline representation of the scene, the modified sample representation of the scene, and the textual labels generated by annotator 470. Annotated output 480 may include a generated label of “nominal” or “variance,” along with the baseline representation and the modified sample representation. The modified sample representation may include a heat map and/or bounding boxes generated by postprocessing module 460 and one or more textual labels generated by annotator 470.

Inference engine 124 may record annotated output 480 for later retrieval, e.g., in storage 114. Additionally or alternatively, inference engine 124 may transmit annotated output 480 to a user for display via any of I/O devices 108 or capture device 400. In various embodiments, one of I/O devices 108 or capture device 400 may display the baseline representation adjacent to the labeled and modified sample representation, facilitating a visual comparison of the two representations by a user. For example, if a region of the modified sample representation includes a textual label of “missing object,” a user may easily examine the corresponding region included in the baseline representation and identify the missing object.

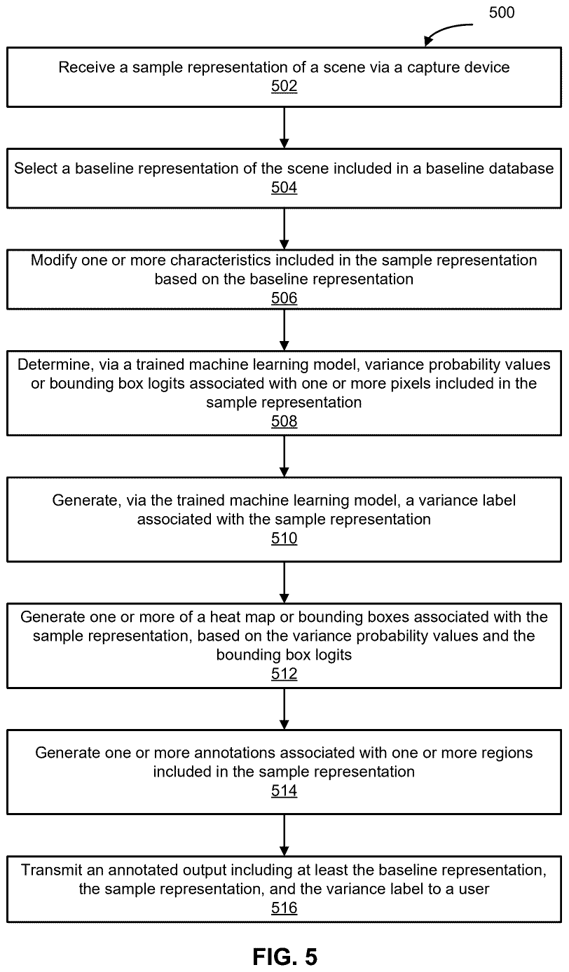

FIG. 5 is a flow diagram of method steps for performing automated variance detection, according to some embodiments. Although the method steps are described in conjunction with the systems of FIGS. 1-2 and 4, persons skilled in the art will understand that any system configured to perform the method steps in any order falls within the scope of the present disclosure.

As shown, in step 502 of method 500, inference engine 124 receives a sample representation of a scene via capture device 400. The sample representation may have one of several modalities, such as a digital raster image, a LiDAR image, an ultrasonic image, or an infrared image. Examples of capture device 400 include, without limitation, a portable telephone, a laptop computer, a digital camera, or a dedicated LiDAR, ultrasonic, or infrared sensor.

In step 504, inference engine 124 selects a baseline representation of the scene included in baseline database 410. In various embodiments, inference engine 124 may select a baseline representation based on a user designation included in user input 420. Alternatively, inference engine 124 may select a baseline representation based on a comparison between the captured sample representation and one or more baseline representations included in baseline database 410.

In step 506, preprocessing module 440 of inference engine 124 modifies one or more characteristics of the captured sample representation based on the baseline representation. Preprocessing module 440 may adjust a resolution of the captured sample representation to match a resolution of the selected baseline representation via any suitable upscaling or downscaling techniques. Preprocessing module 440 may also rotate or scale the captured sample representation to align the captured sample representation to the selected baseline representation. Preprocessing module 440 may further perform image-wide adjustments to the captured sample representation, including adjustments to image brightness, contrast, or sharpness based on corresponding image-wide brightness, contrast, or sharpness measurements associated with the selected baseline representation.

In step 508, inference engine 124 analyzes the captured sample representation and the selected baseline representation via trained model 450. Trained model 450 may include one or more trained machine learning models, where each of the one or more trained machine learning models is operable to detect variance between a baseline representation and a sample representation having a particular modality, such as a digital raster image, a point cloud, or a LiDAR image.

Each of the one or more trained machine learning models included in trained model 450 may include a convolutional neural network. Trained model 450 may generate a vector matrix of pixel-wise variance probabilities, where each entry in the vector matrix included a probability that an associated pixel included in the sample representation exhibits greater than a threshold amount of variance compared to a corresponding pixel included in the associated baseline representation.

Trained model 450 may also generate one or more bounding box logits, where each bounding box logit represents a rectangular region of pixels included in the sample representation that collectively exhibit a variance compared to corresponding pixels included in the baseline representation. A bounding box logit may include two pairs of pixel coordinates (X1, Y1) and (X2, Y2), where (X1, Y1) describes the pixel coordinates within the sample representation that define one corner of a bounding box and (X2, Y2) describes the pixel coordinates within the sample representation that define an opposite corner of the bounding box.

In step 510, trained model 450 may generate a variance label associated with the sample representation. A variance label of “nominal” may indicate that the sample representation does not exhibit at least a threshold amount of variance compared to the corresponding baseline representation. A variance label of “variance” may indicate that the sample representation exhibits at least a threshold amount of variance compared to the corresponding baseline representation.

In step 512, postprocessing module 460 of inference engine 124 generates a heat map and/or one or more bounding boxes associated with the sample representation, based on the vector matrix of pixel-wise variance probabilities and bounding box logits generated by trained model 450. Postprocessing module 460 may modify the color or brightness of each pixel included in the sample representation based on a variance probability value associated with the pixel. The resulting heat map displays different levels of variance probability within the sample representation via different colors or brightness levels.

Postprocessing module 460 may also generate bounding boxes associated with the sample representation based on the bounding box logits generated by trained model 450. Postprocessing module 460 may insert a bounding box into the sample representation, where the location of opposing corners included in the bounding box are determined by the bounding box logits. Postprocessing module 460 may assign a contrasting color to the inserted bounding box for visibility.

In step 514, annotator 470 of inference engine 124 may generate one or more annotations associated with one or more regions included in the sample representation. Based on one or more bounding boxes or other regions of high variance probability within the sample representation, annotator 470 compares pixels included in the bounding box or region of high variance probability to corresponding pixels included in the baseline representation. Based on the comparison, annotator 470 may generate an annotation associated with the region, such as “missing object,” “newly added object,” or “changed object.” In various embodiments, annotator 470 may identify a newly added object included in the sample representation and modify a generated annotation to include a description of the newly added object.

In step 516, inference engine 124 may transmit annotated output 480 to a user, where annotated output 480 includes at least the baseline representation, the sample representation, and any labels or other textual descriptions generated by trained model 450, postprocessing module 460, or annotator 470. In various embodiments, inference engine 124 may transmit annotated output 480 to the user via capture device 400 used to generate the sample representation. Inference engine 124 may display annotated output 480 as a side-by-side presentation of both the baseline and annotated sample representation, so that the user may easily compare the two representations. For example, inference engine 124 may display one or more sentences generated by annotator 470 and included in annotated output 480 that describe the scene depicted in the sample representation and one or more variances between the sample representation and the baseline representation. Inference engine 124 may also store annotated output 480 for later retrieval.

In sum, the disclosed techniques perform automated physical variance detection. The disclosed techniques analyze two or more representations of a scene including one or more objects and identify one or more differences between objects included in the representations. The disclosed techniques may identify one or more objects that are present in one representation of the scene but not in a different representation of the scene. The disclosed techniques may also identify objects whose location, orientation, and/or appearance differ between the two or more representations.

In operation, a training engine modifies a machine learning model based on a training data set that include multiple training scene pairs. Each training scene pair may include a baseline representation of a scene and a sample representation of the scene. The baseline and sample representations of the scene may include raster image data, point clouds, Light Detection and Ranging (LiDAR) sensor data, and/or other sensor data. Each training scene pair may include a label indicating the presence or absence of significant changes in the presence, location, orientation, and/or appearance of one or more objects included in the baseline and/or sample representations. For example, a label value of “nominal” may indicate that there are no significant differences between the object(s) depicted in the baseline and sample representations included in the training scene pair. A label value of “variance” may indicate that one or more objects are included in one representation of the training scene pair but not the other representation of the training scene pair, or that the location, orientation, and/or appearance of one or more objects differ between the representations included in the training scene pair.

Each of the representations included in a training scene pair may also include one or more labels, where each label is associated with a region of the representation. A label may be a textual label associated with an object included in the representation, such as a name or description associated with the object. A label may also denote a region of a representation, such as a boundary included in a training scene pair sample representation denoting a region of the sample representation that differs from the corresponding region included in the baseline representation of the training scene pair. A labeled region of a sample representation may denote a missing object, a new object, or an object whose appearance and/or orientation is different in the sample representation compared to the baseline representation. For a given scene pair included in the training data set, the lighting conditions may differ between the baseline and sample representations. The baseline and sample representations may also differ in the position and/or orientation of a camera or other sensor used to capture the representations. The training engine transmits the modified machine learning model to an inference engine.

The inference engine analyzes paired baseline and sample representations of a scene via the modified machine learning model and generates one or more labels associated with the sample representation. The machine learning model may generate a label of “nominal” to indicate that the contents of the sample representation do not differ from the contents of the baseline representation. The machine learning model may generate a label of “variance” to indicate that one or more objects are not present in both the sample and baseline representations, or that the location, orientation, and/or appearance of one or more objects differ between the sample and baseline representations. The machine learning model may also generate a label denoting a region of the sample representation that differs from a corresponding region included in the baseline representation. The inference engine may further generate a textual label associated with the region that includes an object name and/or description, such as “new object” or “missing wall art.” The inference engine generates an annotated output, where the annotated output includes the sample representation of the scene and one or more generated labels associated with the sample representation. The inference engine may transmit the annotated output and the baseline representation to a user device, such as a laptop computer, portable phone, or sensor capture device.

One technical advantage of the disclosed techniques relative to the prior art is that the disclosed techniques enable automated variance detection in a scene, without requiring checklists or manual human review of reference representations of the scene. The disclosed techniques also enable automated variance detection based on baseline and sample representations of a scene captured under varying lighting conditions or captured from different sensor viewpoints. These technical advantages provide one or more improvements over prior art approaches.
1. In some embodiments, a computer-implemented method for performing automated variance detection, the computer-implemented method comprises recording, via a capture device, a sample representation of a scene including one or more objects, selecting a baseline representation of the scene from a baseline database, generating, via a machine learning model, a variance probability value associated with each of one or more pixels included in the sample representation, generating a variance label associated with the sample representation, and transmitting at least the sample representation and the variance label to the capture device.
2. The computer-implemented method of clause 1, wherein the variance label indicates a presence or absence of at least a threshold amount of variance between the baseline representation and the sample representation.
3. The computer-implemented method of clauses 1 or 2, further comprising generating one or more textual labels associated with the sample representation, wherein each of the one or more textual labels is associated with a missing object, a newly added object, or a change in appearance associated with an object.
4. The computer-implemented method of any of clauses 1-3, further comprising simultaneously displaying, via the capture device, the baseline representation, the sample representation, and the variance label.
5. The computer-implemented method of any of clauses 1-4, wherein each of the baseline representation and the sample representation include a digital raster image, a point cloud, a light detection and ranging (LiDAR) image, an ultrasonic image, or an infrared image.
6. The computer-implemented method of any of clauses 1-5, further comprising generating one or more bounding box logits, where each of the one or more bounding box logits defines a region of pixels included in the sample representation.
7. The computer-implemented method of any of clauses 1-6, wherein the selection of the baseline representation of the scene from the baseline database is based on user input or a similarity between the baseline representation and the sample representation.
8. The computer-implemented method of any of clauses 1-7, further comprising scaling the sample representation, rotating the sample representation, or modifying a first resolution associated with the sample representation based on a second resolution associated with the baseline representation.
9. The computer-implemented method of any of clauses 1-8, wherein the machine learning model includes a convolutional neural network.
10.The computer-implemented method of any of clauses 1-9, further comprising generating a vector matrix based on the variance probability values associated with the one or more pixels included in the sample representation.
11. In some embodiments, one or more non-transitory computer-readable media store instructions that, when executed by one or more processors, cause the one or more processors to perform the steps of recording, via a capture device, a sample representation of a scene including one or more objects, selecting a baseline representation of the scene from a baseline database, generating, via a machine learning model, a variance probability value associated with each of one or more pixels included in the sample representation, generating a variance label associated with the sample representation, and transmitting at least the sample representation and the variance label to the capture device.
12.The one or more computer-readable media of clause 11, wherein the variance label indicates a presence or absence of at least a threshold amount of variance between the baseline representation and the sample representation.
13.The one or more computer-readable media of clauses 11 or 12, further comprising generating one or more textual labels associated with the sample representation, wherein each of the one or more textual labels is associated with a missing object, a newly added object, or a change in appearance associated with an object.
14.The one or more computer-readable media of any of clauses 11-13, further comprising simultaneously displaying, via the capture device, the baseline representation, the sample representation, and the variance label.
15.The one or more computer-readable media of any of clauses 11-14, wherein each of the baseline representation and the sample representation include a digital raster image, a point cloud, a light detection and ranging (LiDAR) image, an ultrasonic image, or an infrared image.
16.The one or more computer-readable media of any of clauses 11-15, further comprising generating one or more bounding box logits, where each of the one or more bounding box logits defines a region of pixels included in the sample representation.
17.The one or more computer-readable media of any of clauses 11-16, wherein the selection of the baseline representation of the scene from the baseline database is based on user input or a similarity between the baseline representation and the sample representation.
18.The one or more computer-readable media of any of clauses 11-17, further comprising scaling the sample representation, rotating the sample representation, or modifying a first resolution associated with the sample representation based on a second resolution associated with the baseline representation.
19. In some embodiments, a system comprises one or more memories for storing instructions, and one or more processors for executing the instructions to generate, via a machine learning model, one or more measures of variance associated with a training pair of representations of a scene, wherein the training pair of representations includes a baseline representation of the scene and a sample representation of the scene, and wherein the one or more measures of variance are based on differences between the baseline representation and the sample representation, generate one or more loss values based on the one or more measures of variance and one or more training annotations associated with the training pair of representations, and modify the machine learning model based on the one or more loss values.
20.The system of clause 19, wherein the one or more training annotations include a label indicating whether there is greater than or less than a threshold amount of variance between the baseline representation and sample representation included in the training pair of representations. Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for performing automated variance detection, the computer-implemented method comprising:
recording, via a capture device, a sample representation of a scene including one or more objects;
selecting a baseline representation of the scene from a baseline database;
generating, via a machine learning model, a variance probability value associated with each of one or more pixels included in the sample representation;
generating a variance label associated with the sample representation; and
transmitting at least the sample representation and the variance label to the capture device.

2. The computer-implemented method of claim 1, wherein the variance label indicates a presence or absence of at least a threshold amount of variance between the baseline representation and the sample representation.

3. The computer-implemented method of claim 1, further comprising generating one or more textual labels associated with the sample representation, wherein each of the one or more textual labels is associated with a missing object, a newly added object, or a change in appearance associated with an object.

4. The computer-implemented method of claim 3, further comprising simultaneously displaying, via the capture device, the baseline representation, the sample representation, and the variance label.

5. The computer-implemented method of claim 1, wherein each of the baseline representation and the sample representation include a digital raster image, a point cloud, a light detection and ranging (LiDAR) image, an ultrasonic image, or an infrared image.

6. The computer-implemented method of claim 1, further comprising generating one or more bounding box logits, where each of the one or more bounding box logits defines a region of pixels included in the sample representation.

7. The computer-implemented method of claim 1, wherein the selection of the baseline representation of the scene from the baseline database is based on user input or a similarity between the baseline representation and the sample representation.

8. The computer-implemented method of claim 1, further comprising scaling the sample representation, rotating the sample representation, or modifying a first resolution associated with the sample representation based on a second resolution associated with the baseline representation.

9. The computer-implemented method of claim 1, wherein the machine learning model includes a convolutional neural network.

10. The computer-implemented method of claim 1, further comprising generating a vector matrix based on the variance probability values associated with the one or more pixels included in the sample representation.

11. One or more non-transitory computer-readable media storing instructions that, when executed by one or more processors, cause the one or more processors to perform the steps of:
recording, via a capture device, a sample representation of a scene including one or more objects;
selecting a baseline representation of the scene from a baseline database;
generating, via a machine learning model, a variance probability value associated with each of one or more pixels included in the sample representation;
generating a variance label associated with the sample representation; and
transmitting at least the sample representation and the variance label to the capture device.

12. The one or more computer-readable media of claim 11, wherein the variance label indicates a presence or absence of at least a threshold amount of variance between the baseline representation and the sample representation.

13. The one or more computer-readable media of claim 11, further comprising generating one or more textual labels associated with the sample representation, wherein each of the one or more textual labels is associated with a missing object, a newly added object, or a change in appearance associated with an object.

14. The one or more computer-readable media of claim 13, further comprising simultaneously displaying, via the capture device, the baseline representation, the sample representation, and the variance label.

15. The one or more computer-readable media of claim 11, wherein each of the baseline representation and the sample representation include a digital raster image, a point cloud, a light detection and ranging (LiDAR) image, an ultrasonic image, or an infrared image.

16. The one or more computer-readable media of claim 11, further comprising generating one or more bounding box logits, where each of the one or more bounding box logits defines a region of pixels included in the sample representation.

17. The one or more computer-readable media of claim 11, wherein the selection of the baseline representation of the scene from the baseline database is based on user input or a similarity between the baseline representation and the sample representation.

18. The one or more computer-readable media of claim 11, further comprising scaling the sample representation, rotating the sample representation, or modifying a first resolution associated with the sample representation based on a second resolution associated with the baseline representation.

19. A system comprising:
one or more memories for storing instructions; and
one or more processors for executing the instructions to:
generate, via a machine learning model, one or more measures of variance associated with a training pair of representations of a scene, wherein the training pair of representations includes a baseline representation of the scene and a sample representation of the scene, and wherein the one or more measures of variance are based on differences between the baseline representation and the sample representation;
generate one or more loss values based on the one or more measures of variance and one or more training annotations associated with the training pair of representations; and
modify the machine learning model based on the one or more loss values.

20. The system of claim 19, wherein the one or more training annotations include a label indicating whether there is greater than or less than a threshold amount of variance between the baseline representation and sample representation included in the training pair of representations.
